(19) United States
(12) Patent Application Publication
(10) Pub. No.: US 2012/0129081 A1
(43) Pub. Date: May 24, 2012

(54) FUEL CARTRIDGE

(76) Inventor: Yasuaki Nakamura, Shizuoka (JP)

(21) Appl. No.: 12/162,319

(22) PCT Filed: Jan. 26, 2007
(86) PCT No.: PCT/US07/02105

§ 371 Date: Jul. 30, 2008

(30) Foreign Application Priority Data
Jan. 27, 2006 (JP) 2006-018503

(51) Int. Cl. H01M 8/04

(52) U.S. Cl. 429/515

(57) ABSTRACT

The existing problem is supplying fuel at a fixed flow rate to a fuel cell, and moreover, miniaturization of the device in which the fuel cell is loaded, in a fuel cartridge for a fuel cell. The fuel cartridge for a fuel cell is equipped with a container main body that is equipped with a connection part that connects to the fuel cell, and houses the fuel that is supplied to the fuel cell in its interior, and a push out means for pushing out the fuel, and a valve that has a supply port for supplying fuel to the fuel cell, and that opens the supply port in response to the operation connecting the container main body to the fuel cell. On the connection part there is provided a pressure regulating mechanism, one end of which communicates with the valve, and the other end of which communicates with the inside of the container main body, and that causes the fuel that is housed in said interior to flow out to the valve, by regulating to a secondary pressure lower than the primary pressure inside the container main body.

### BACKGROUND OF THE INVENTION

1. Field of the Invention

The present invention relates to a fuel cartridge for a fuel cell, and relates in particular to a fuel cartridge that is equipped with a pressure regulating mechanism.

2. Description of the Related Art

A fuel cell is an energy conversion apparatus that causes a chemical reaction between hydrogen and oxygen, and generates electricity, owing to the fact that the electrolyte membrane that separates a fuel such as hydrogen, methanol, etc. and oxygen permits hydrogen ions to pass through it, and given the fact that the operating temperature is low, and miniaturization of the apparatus can be anticipated, it is currently used for various purposes, and development has been promoted in such fields as the power supply for mobile devices such that the continuous operating time of for example notebook personal computers and portable telephones can be lengthened.

Then, to replenish the fuel in the fuel cell that is used for said power supply for mobile devices, etc., a fuel container that supplies fuel (for example, a fuel cartridge) has been proposed.

Ordinarily, a fuel cell is loaded inside a device such as the above-mentioned mobile devices, and a pressure regulator (a so-called governor) is installed such that the fuel is supplied at a fixed pressure to said loaded fuel cell.

However, miniaturization of mobile devices like those described above has advanced over the years, and in the future further miniaturization is hoped for, so the space available for loading the governor inside the mobile devices continues to become smaller and smaller.

Accordingly, to supply fuel to a fuel cell on which a governor has not been installed, there have been proposed a fuel cell (Japanese Patent Bulletin Number 3,550,396) that houses the fuel in a container with flexibility, and supplies fuel to the fuel cell while regulating optionally the flow rate by for example pressing the container with a fixed strength with the hand, and a fuel container (Unexamined Japanese Patent Application Number 2005-216817) that disposes a capillary tube on the supply port of a fuel container, and supplies fuel at a fixed flow rate to the fuel cell by employing capillary action.

### BRIEF SUMMARY OF THE INVENTION

### Description of the Invention

### Problems that the Invention Attempts to Solve

However, in the case of the former fuel container with flexibility, the flow rate is determined by the force of the pressing by the human hand, so when for example the force of the pressing is too strong, the fuel inside the fuel cell is discharged in a rush, and the electrolyte membrane of the fuel cell, which is the place to which the fuel is supplied, is torn by the pressure of the injected fuel.

In the case of the latter fuel container that utilizes capillary action, the fuel inside the fuel container is supplied slowly at a fixed flow rate, so when the fuel cell requires a large amount of fuel, it ends up taking time for the fuel to be supplied.

The present invention was created in light of this state of affairs, and takes as its purpose the provision of a fuel cartridge for a fuel cell that supplies fuel to a fuel cell at a fixed flow rate, and that moreover can realize further miniaturization of devices in which fuel cells are loaded.

### Means for Solving the Problems

The inventive fuel cartridge for a fuel cell is equipped with a container main body, which is equipped with a connection part that connects to a fuel cell, and that houses inside it the fuel that is supplied to the above-mentioned fuel cell, and the push out means for pushing out said fuel, and a valve that is provided on the above-mentioned connection part, that has a supply port for supplying fuel to the above-mentioned fuel cell, and that opens the above-mentioned supply port in response to the operation of connecting the above-mentioned container main body to the above-mentioned fuel cell, wherein one end communicates with the above-mentioned connection part, and the other end communicates with the inside of the above-mentioned container main body, and there is provided a pressure regulating mechanism that causes the fuel housed in said interior to flow out to the above-mentioned valve by regulating to secondary pressure lower than the primary pressure inside the above-mentioned container main body.

It is preferable that in the inventive fuel cartridge for a fuel cell described the above-mentioned one end of the above-mentioned pressure regulating mechanism is equipped with a filter in the space between it and the above-mentioned valve.

In the inventive fuel cartridge for a fuel cell, the above-mentioned container main body is equipped with a partition wall that has a communication hole in roughly the center between the above-mentioned connection part and the above-mentioned interior, and the above-mentioned connection part is equipped with a roughly columnar intermediate member whose outer circumferential surface is fixed to the inner surface of the above-mentioned connection part, and that has a shaft hole in roughly the center, between the above-mentioned valve and the above-mentioned pressure regulating mechanism, and the above-mentioned pressure regulating mechanism is equipped with a diaphragm that has a first shaft part that protrudes to the above-mentioned valve side and is inserted in the above-mentioned shaft hole, and a second shaft part that protrudes to the above-mentioned internal side and is inserted through the above-mentioned communication hole, and that displaces in response to the pressure fluctuations of the above-mentioned fuel, the above-mentioned first shaft part has a first annular groove part on the outer periphery of the tip, and on said groove part there is installed a sliding bulkhead member that slides through the inner surface of the above-mentioned shaft hole, and that partitions it into a pressure regulating chamber in communication with the above-mentioned valve that is formed on the above-mentioned valve side and an air chamber housing air that is formed on the above-mentioned partition wall side, a discharge port that is in communication with the above-mentioned pressure regulating chamber and that discharges the above-mentioned fuel is provided on the tip of the above-mentioned first shaft part, the above-mentioned second shaft part has a second annular groove part on the outer periphery of its tip, and on said groove part there is installed pressure regulating valve that opens and closes the above-mentioned communication hole in response to the movement of said second shaft part in an axial direction, an inflow port that communicates with the above-mentioned interior and through which the above-mentioned fuel flows when the above-mentioned pressure regulating valve is open is provided on the outer peripheral surface of the above-mentioned valve side from said pressure regulating valve of the above-mentioned second shaft part, and a flow path that reaches from the above-mentioned inflow port to the above-mentioned discharge port is formed on the inside of the above-mentioned diaphragm.

In the inventive fuel cartridge for a fuel cell, the above-mentioned intermediate member is equipped on the above-mentioned valve side with a spring member used for a valve, one end of which is placed in direct contact with said valve, and the other end of which is in direct contact with the above-mentioned intermediate member, and that expands and contracts in response to the displacement of the above-mentioned valve, and is equipped on the above-mentioned diaphragm side with a with a spring member used for a diaphragm, one end of which is placed in direct contact with said diaphragm, and the other end of which is in direct contact with the above-mentioned intermediate member, and that expands and contracts in response to the displacement of the above-mentioned diaphragm, and the above-mentioned spring member for a valve and the above-mentioned spring member for a diaphragm have different diameters, and are disposed such that at least a part of each overlaps in the expansion and contraction direction of said spring coaxially.

In the inventive fuel cartridge for a fuel cell, the above-mentioned spring member for a valve has a diameter that is smaller than that of the above-mentioned spring member for a diaphragm.

In the inventive fuel cartridge for a fuel cell, the above-mentioned push out means is the compressed gas or liquefied gas housed inside the above-mentioned container main body.

In the fuel cartridge for a fuel cell, the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

### BRIEF DESCRIPTION OF THE DRAWINGS

FIG. 1 is a central section of the fuel cartridge for a fuel cell 1.

FIG. 2 is an oblique view of an enlarged section of the connection part.

FIG. 3 is an exploded oblique view in section of the chief parts in FIG. 1.

FIG. 4 is an oblique view in section of the diaphragm.

FIG. 5 is an enlarged section of the connection part of the fuel cartridge for a fuel cell ‘1’ for another mode of embodiment.

### DETAILED DESCRIPTION OF THE INVENTION

### Effects of the Invention

Since in the inventive fuel cartridge for a fuel cell there is provided a pressure regulating mechanism that causes the fuel that is housed inside the container main body to flow out to a valve, by regulating to a secondary pressure lower than the primary pressure inside the container main body, it can supply fuel to a fuel cell at a fixed flow rate without loading a pressure regulator on the device on the fuel cell is loaded. Owing to this, it is possible to prevent fuel from being supplied abruptly to the fuel cell, and it is moreover possible to miniaturize the space part of the above-mentioned device where the pressure regulating mechanism is loaded. In addition, since the pressure regulating mechanism is provided on the connection part such one end thereof communicates with the valve and the other end thereof communicates with the inside of the container main body, the open space inside the connection part is reduced by just that amount of space in which the pressure regulating mechanism is disposed. Owing to this, it is possible to reduce the fuel that ends up remaining, albeit in minute quantities, inside the connection part, when the connection between the fuel cartridge for a fuel cell and the fuel cell is loosened.

### Preferred Embodiment of the Invention

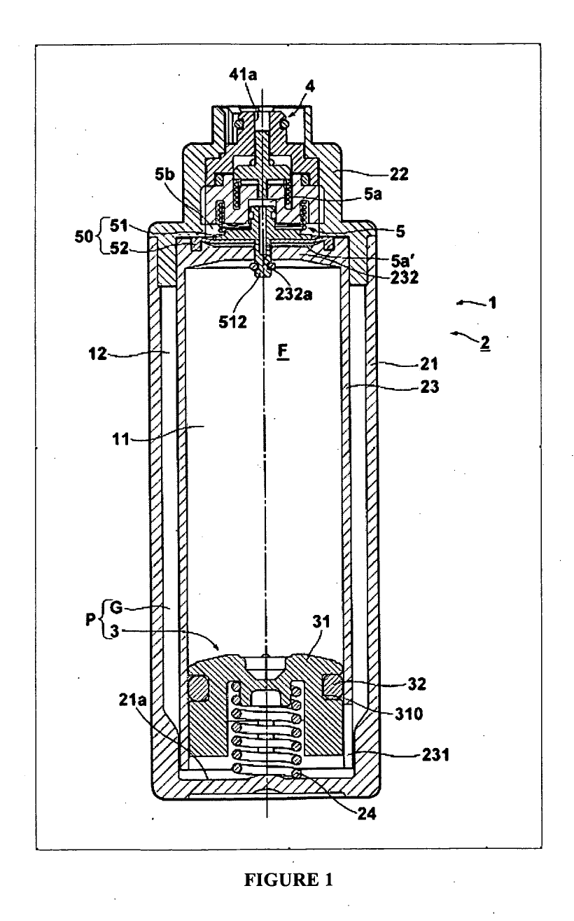

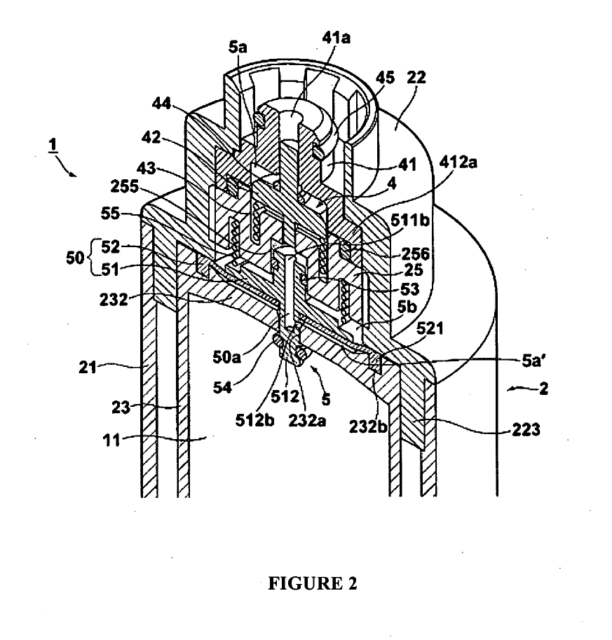

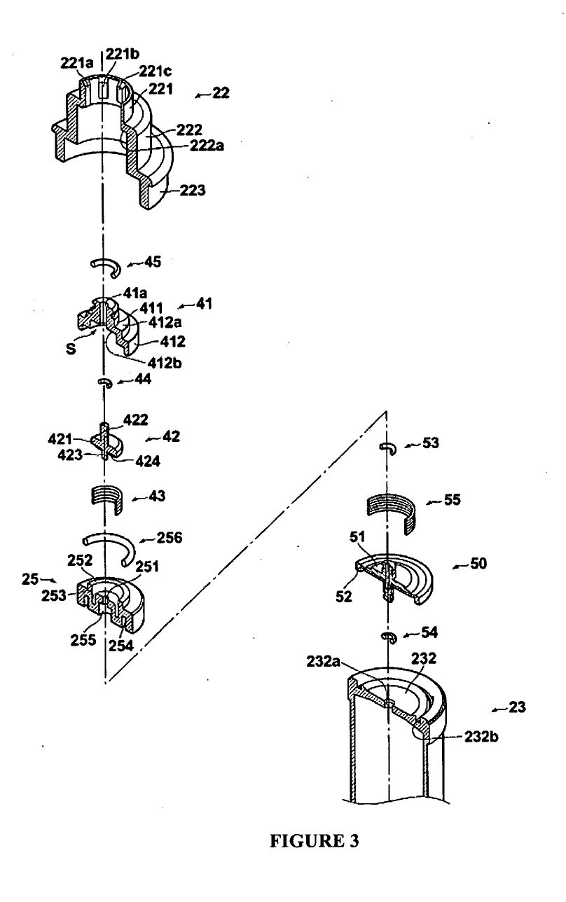

Next, a detailed description of one mode of embodiment of the fuel cartridge for a fuel cell for the present invention is provided with reference to figures. FIG. 1 is a central section of the fuel cartridge for a fuel cell 1 in the present mode of embodiment. FIG. 2 is an enlarged oblique view of the upper end of the fuel cartridge for a fuel cell 1 in FIG. 1. FIG. 3 is an exploded oblique view of the chief parts of the fuel cartridge for a fuel cell 1 in FIG. 1. The fuel cartridge for a fuel cell 1 in the present mode of embodiment house fuel F in its interior, and by installing it for example on a small portable terminal of a notebook personal computer, PDA (personal data assistant), digital camera, digital video recorder, etc., in which a fuel cell like DMFC is embedded (hereinafter, “device”), it is a fuel cartridge for a fuel cell that supplies fuel to the fuel cell. For the sake of convenience in the present mode of embodiment, the side that connects to the fuel cell (upwards in FIG. 1) is taken to be the upper side.

As shown in FIG. 1, the fuel cartridge for a fuel cell 1 is generally composed of a container main body 2 that houses fuel F inside it and a push out means that is composed of compressed gas G and a piston 3 for pushing out the fuel F, and that has a connection part 22 for connecting to the device (not shown in the figure) on its upper end, a valve that is provided on the connection part 22 and that opens or cuts off the distribution of the fuel F that is housed in the container main body 2, and a pressure regulating mechanism 5 that is provided on the connection part 22 and that causes the fuel F that is housed inside the container main body 2 to flow out to the valve 4 by regulating to a secondary pressure lower than the primary pressure inside the container main body 2.

In the present mode of embodiment there are no particular limits on the fuel F, and for example when the fuel cell is a DFMFC it is a mixed liquid of methanol and purified water, and it may be modified as appropriate in accordance with the type of fuel cell, to such things as a mixed liquid of an alcohol with a fixed concentration of ethanol and purified water, etc., and purified water or an alcohol simple substance, etc. In addition, in the present mode of embodiment it is desirable from the standpoint of preventing the in-mixing into the fuel F of oxygen, which has an adverse effect on the reactions in the fuel cell, and moreover from the standpoint of preventing the fuel F from oxidizing, that nitrogen, carbon dioxide, or a gas that does not contain oxygen such as deoxygenated air is used. This was used as the compressed gas G in the present mode of embodiment, but the present invention is not limited to this, and it may for example be liquefied gas wherein DME (dimethyl ether) is gasified.

As shown in FIG. 1 and FIG. 2, the container main body 2 is generally composed of a roughly cylindrical outer container 21 whose upper end part is open, a connection part 22 that is installed on the upper end of the outer container 21, and whose upper end is connected with the device (not shown in the figure), and an inner container that is disposed in a double structure inside the outer container.

As shown in FIG. 1, the inside of the container main body 2 is equipped with a space for housing fuel 11 that is formed on the inside of the inner container and that houses the fuel F, a space for pushing out 12 that is formed chiefly between the outer surface of the inner container 23 and the inner surface of the outer container 21, and that seals the compressed gas G that generates pressure for pushing out the fuel F, a piston 3 hat is disposed such that it can slide up and down in the inner container 23, and that partitions the space for housing fuel 11 and the space for pushing out 12, and an elastic body 24 that is compressed in the space with bottom inner surface 21a of the outer container 21 when the piston 3 moves downwards.

There are no particular limits in the present invention when it comes to said elastic body 24, but in the present mode of embodiment a spring and the like are for example used. The volume ratios of the space for housing fuel 11 and the space for pushing out 12 fluctuate depending on the position of the piston 3, and when the fuel F decreases and the piston 3 rises, a part of the space for pushing out 12 ends up located inside the inner container 23.

The inner container 23 is roughly cylindrical with the lower end open, and the lower end part thereof is disposed without it being in contact in the bottom inner surface 21a of the outer container 21. In addition, a plurality of notches 231 that extend in a vertical direction are formed on the peripheral surface of the lower end side thereof, and when the piston moves downwards, the inside of the inner container 23 and the inside of the outer container can communicate. (A detailed explanation is provided below.) As shown in FIG. 2 and FIG. 3, on the upper end of the inner container 23 there is provided a roughly flat partition wall 232 that has a communication hole 232a in which the lower shaft part 512 of the diaphragm 50 (described below) on roughly the center thereof. On the outer peripheral part of the upper surface of the partition wall 232 there is provided a mating indentation 232b for mating with the lower surface of the diaphragm main body 52 (described below), and the upper surface of the partition wall 232, that is, the upper end of the inner container 23, and the upper end of the outer container 21, are disposed in roughly the same plane. When the upper ends of the outer container 21 and the inner container 23 are disposed in roughly the same plane in this manner, it is possible to increase the size of the space for housing fuel 11 that is formed inside the inner container 23, and it is possible to raise the volume ratio of the space for housing fuel 11 inside the container main body 2.

As shown in FIG. 3, the connection part 22 has a roughly cylindrical connection part main body 222 that is equipped with a tubular connection tube part 221 on its upper end. A mating annular body 223 that is inserted between the outer surface of the inner container 23 and the inner surface of the outer container 21, and that mates with the inner container 23 and the outer container 21, is provided on the lower end of the connection main body 222, and the connection part 22 is fixed to the outer container 21 and the inner container 23 by said mating annular body 223. In addition, a reference protrusion 221a that extends downwards from the upper end surface of the connection tube part 221, and that serves as a reference for the absolute position, is formed in one place of the inner periphery, on the inner surface of the connection tube part 221, and moreover two selective protrusions 221b and 22c whose width differs from that of the reference protrusion 221a are formed in positions that are set beforehand in accordance with the type of fuel. On the other hand, a reference groove on the device side, which corresponds to the above-mentioned reference protrusion 221a, and selective grooves on the device side that correspond to the above-mentioned selective protrusions 221b and 221c, are formed on the connection part of the device (not shown in the figure) in which the fuel cell is embedded, and corresponding to this, the width of the reference groove on the device side is wider than that of the selective grooves on the device side, so even if the user attempts to connect inadvertently the reference protrusion 221a will not mate with anything other than the reference groove on the device side.

In the present mode of embodiment, only one reference protrusion 221a for positioning is provided, but the present invention is not limited to this, and a plurality of reference protrusions may be provided for example at a point-symmetric position in relation to the center of the connection tube part 221. In that case, selective protrusions are also formed in point-symmetric positions. In addition, selective protrusions may also be provided on both the outer periphery and the inner periphery of the cylindrical body. Moreover, numerous combined patterns in which the widths and/or positions of the selective protrusions are varied can be imagined. In addition, since the present mode of embodiment makes the shape of the connection tube part 221 differ, there are cases where the selective protrusions 221b and 221c are provided on the inner periphery of the connection tube part 221, but these are not limited to protrusions and may also be grooves. In addition, one may alter the gauge of the connection tube part 221 in accordance with the type of fuel F. Moreover, in the present mode of embodiment, a cylindrical connection tube part 221 is used, but it is not limited to a cylindrical shape, and may for example be a square tube shape, and design changes are possible as appropriate in accordance with the shape of the connection part on the device side and the type of fuel F. According to the above-described mode of embodiment, the shape of the connection tube is caused to differ in accordance with the type of fuel F, so a fuel cartridge for a fuel cell 1 that houses a fuel F of a different type from the fuel F that serves as the purpose cannot be installed on the connection part on the device, and it is possible to prevent erroneous installation of a fuel cartridge for a fuel cell 1.

As shown in FIG. 2, the valve 4 is generally composed of a housing 41 as the fixing member to the connection part 22 and the fitting member to the connection part on the device, a stem 42 that moves in response to connection with the device (not shown in the figure), a spring member for the valve 4 that impels the stem 42 in a closed direction, a valve body 44 that opens or cuts off the distribution of fuel F, and a connection seal member 45 that acts as the seal member when there is a connection with the device, and these are preferably formed with non-metal materials.

As shown in FIG. 3, the housing 41 is equipped on its upper end with an installation tube part 41a for supplying fuel F to the fuel cell, and a housing main body 412 that has a step part 412a that is in direct contact with the inner surface of the upper end 222a of the above-mentioned connection part main body 222 on the outer periphery, and in whose inside a space S is formed, is provided on the lower end of said installation tube part 411. The above-mentioned connection seal member 45 is fitted to the outer periphery of the upper end of the installation tube part 411. The step part 412a of the housing 41 is installed on the inside of the above-mentioned connection part 22 such that it is in direct contact with the inner surface of the upper end 222a, and the lower end of the housing main body 412 is in direct contact with the upper surface of the intermediate member 25 (described below).

The stem 42 is equipped with a roughly columnar large diameter part 421, an upper shaft part 422 that extends upwards of said large diameter part 421, and a lower shaft part 423 that extends downwards. A flow path groove 424 is formed at equally spaced squares, facing outwards from the outer periphery of the lower shaft part 423, is formed on the lower surface of the large diameter part 421. Then, the upper shaft part 422 of the stem 42 is inserted such that it can move in an axial direction through the inside of the supply port 41a of the housing 41, a spring member for the valve 43 is disposed between the lower surface of the large diameter part 421 and the upper surface of the intermediate element 25 (described below), and is impelled upwards. A valve body 44 based on an O-ring is installed on the outer periphery of the base part of the upper shaft part 422 of the stem 42, and by pressing this into contact with the lower end of the supply port 41a, that is, the inner surface of the upper end of the housing main body 412, the supply port 41a is closed and the distribution of fuel F is cut off. In addition, when the upper surface of the upper shaft part 422 is pushed in downwards, the spring member for the valve 43 contracts and the stem 42 moves downwards, and the valve body 44 is separated from the inner surface of the upper end 412b of the housing main body 412, and owing to this the supply port 41a opens, and the distribution of fuel F inside the space for housing fuel 11 is released. Then, the fuel F that passes through the gap between the outer peripheral surfaces of the flow path groove 424 and the large diameter part 421 and the inner peripheral surface of the housing main body 412 or the inner peripheral surface of the annular protrusion 252 of the intermediate member 25 is supplied to the fuel cell through the gap between the outer peripheral surface of the upper shaft part 422 and the inner surface of the supply port 41a.

As shown in FIG. 1 and FIG. 2, a roughly columnar intermediate part 25 whose outer peripheral surface is fixed to the inner surface of the of the connection part main body 222 is disposed downwards from the valve 4. As shown in FIG. 3, the intermediate member 25 has a roughly columnar shape that has a through hole 251 in roughly the center thereof, and an annular protrusion 252 is provided such that it protrudes upwards surrounding the through hole 251 on the upper surface, and moreover a first annular groove 253 that extends downwards from the inner surface of the annular protrusion 252 is formed thereon. The lower shaft part 423 of the above-described stem [42] is inserted in the through hole 251 such that it can move in an axial direction (the up and down direction), and the above-described spring member for a valve 43 is inserted in the first annular groove 253. A shaft hole 255 with a diameter larger than the through hole 251 is formed up a prescribed position upwards on roughly the center thereof, and second annular groove 254 is formed surrounding said shaft hole 255 and moreover to the outside from the first annular groove 253. At this time, the first annular groove 253 and the second annular groove 254 are formed coaxially, and a portion thereof overlaps in the depth direction of the groove (the up and down direction). Owing to the fact that it is formed such that the first annular groove 253 and the second annular groove are superimposed coaxially in this manner, the spring member for the valve 43 and the spring member for the diaphragm (described below) can be disposed coaxially such that the expansion and contraction directions (the up and down direction) of said spring members 43 and 55 overlap, so it is possible to prevent the outer shape of the fuel cylinder for a fuel cell 1 from becoming larger in the up and down direction. Then, the outer peripheral surface of the intermediate member 25 is fixed to the inner surface of the above-described connection part main body 222, and moreover is fixed to the inner surface of the above-described housing main body 412 through an O-ring for the intermediate member 256 that is installed on the outer periphery of the annular protrusion 252.

What is characteristic in the present invention is that there is provided on the inside of the connection part 22 a pressure regulating mechanism 5 whose upper end communicates with the valve 4 and whose lower end communicates with the inside of the container main body 2, and that causes the fuel F housed in said interior to flow out to the valve, by regulating from a primary pressure inside the container main body 2 to a lower secondary pressure.

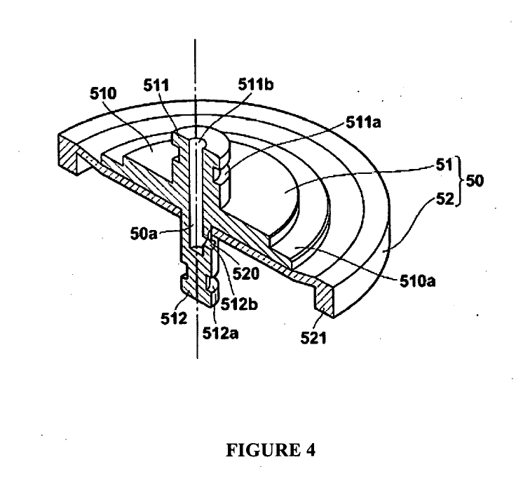

The pressure regulating mechanism 5 is generally composed of a diaphragm 50, a sliding bulkhead member 53 and a pressure regulating valve 54 that are installed on said diaphragm 50, and a spring member for a diaphragm 55 that extends and contracts in response to the displacement of the diaphragm 50. Here, FIG. 4 shows an oblique view in section of the diaphragm 50.

As shown in FIG. 4, the diaphragm is composed of a mobile main body 51 that is positioned on the valve 4 side (the upper side) and a diaphragm main body 52 that is fixed to the lower surface of said mobile main body 51 and is positioned on the partition wall 232 side.

The mobile main body 51 is formed of a resin such as polypropylene (PP), polyethylene (PE), polyoxymethyl (POM), polyethylene terephthalate (PET), polyethylene naphthalate (PEN), polybutylene terephthalate (PBT), polybutylene naphthalate (PBN) and polyacrylonitrile (PAN), and is generally composed of a roughly columnar main body 510, an upper shaft 511 (the first shaft part) that is protruded upwards in roughly the center of the upper surface of said main body 510, and a lower shaft 512 (the second shaft part) that is protruded downwards in roughly the center of the upper surface of said main body 510. A step part 510a with which the spring member for a diaphragm 55 is in direct contact is formed on the upper surface rim side of the main body 510, the upper part of the spring member for a diaphragm 55 is inserted in the second annular groove 254, the upper part thereof is in direct contact with the bottom part of the second annular groove 254, and the lower end thereof is in direct contact with the step part 510a.

The upper shaft 511 is inserted in the above-described shaft hole 255, and a sliding bulkhead member 53 that has an upper annular groove part 511a (first annular groove part), and that slides through the inner surface of the shaft hole 255 on said groove part 511a, is installed on the outer periphery of the upper end thereof. Said sliding bulkhead member 53 is partitioned into a space 5a (hereinafter, “pressure regulation chamber”) on the valve side 4 that communicates with the valve 4 through the space inside the connection part 22, and a space 5b (hereinafter, “atmospheric chamber”) on the partition wall 232 side in which air is housed. In addition, a discharge port 511b that communicates with the pressure regulation chamber 5a and discharges the fuel F that is housed inside the container main body 2 is provided in roughly the center of the upper end surface of the upper shaft 511.

The lower shaft 512 is inserted through the above-described through hole 232a and the lower end is positioned in the space for housing fuel 11, and a pressure regulating valve 54 that has a lower annular groove part 512a (second annular groove part), and that opens and closes the through hole 232a in response to the movement of the lower shaft 512 on said groove part 512a, is installed on the outer periphery of the lower end thereof. Said pressure regulating valve 54 opens and closes the through hole 232a due to the fact that it is in direct contact with the lower surface of the partition wall 232. An inflow port 512b that communicates with the space for housing fuel 11 when the pressure regulating valve 54 is open, and through which the fuel F housed inside said space 11 flows in, is provided on the outer peripheral surface above the lower annular groove part 512a of the lower shaft 512.

In the mobile main body composed in this manner, a flow path 50a that extends downwards from the discharge port 511b to a prescribed position of the lower shaft along the shaft core is formed on the interior thereof. The prescribed position refers to a position lower than the inflow port 512b, and the flow path 50a communicates with the inflow port 512b. Then, the mobile main body 51 has a diaphragm body 52 on the lower side, and the upper surface of said diaphragm main body 52 is fixed to the lower surface of the main body 51.

The diaphragm main body 52 is composed for example of rubber, and is generally a plate-shaped member with elasticity, and a round opening 520 through which the lower shaft 512 inserted is pierced through in roughly the center thereof, and an annular wall is hung down on the outer periphery thereof. As shown in FIG. 2, said annular wall 521 mates with the mating indentation 232b of the above-described partition wall 232, and the diaphragm main body 52 is fixed to the container main body 22 owing to the fact that the upper surface of the annular wall 521 is pressed against the lower end of the connection main body 222, and the lower surface thereof is pressed against the bottom part of the mating protrusion 232b, respectively. A space 5a′ is formed between the lower surface of the diaphragm main body 52 and the upper surface of the partition wall 232, said space 5a′ communicates with the above-described pressure regulating chamber 5a through the flow path 50a, and moreover communicates with the space for housing fuel 11 when the pressure regulating valve 54 is open. Hereinafter, this space 5a′ is called “this pressure regulating chamber 5a′”.

This diaphragm 50 is formed due to the fact that the above-described mobile body 51 and the diaphragm main body 52 are molded in a monobloc by two-color molding. In the case of the diaphragm 50 in the present mode of embodiment, the mobile main body 51 and the diaphragm main body 52 were molded by two-color molding, but the inventive diaphragm is not limited to this, and it may be an item where the mobile main body 51 and the diaphragm main body 52 are molded separately and fixed to one another.

A description is now provided of the operation of the pressure regulating mechanism 5 that is composed in this manner. The diaphragm 50 has been set such that the inside of the pressure regulating chamber 5a and this pressure regulating chamber 5a′ become a secondary pressure lower than the primary pressure by the spring member for a diaphragm 55, relative to the primary pressure of the fuel F that is supplied from the inside of the container main body 2. Then, when the pressure of the fuel F inside the pressure regulating chamber 5a and this pressure regulating chamber 5a′ becomes higher than the above-mentioned secondary pressure, the fuel F inside the pressure regulating chamber 5a pushes the upper shaft 511 downwards, and the fuel F inside this pressure regulating chamber 5a′ pushes the lower surface of the diaphragm main body 52 upwards. At this time, the area of the lower surface of the diaphragm main body 52 is larger than the area of the upper end of the upper shaft 511, so force that moves upwards from downwards is applied to the diaphragm 50. As a result, the lower shaft 512 of the mobile main body 51 moves upwards in opposition to the impetus due to the spring member for the diaphragm 55, the pressure regulating valve 54 shuts off the through hole 232a of the partition wall 232, and this blocks any more of the fuel F from flowing into this pressure regulating chamber 5a′ and the pressure regulating chamber 5a. In addition, when contrary to this the pressure of the fuel F inside the pressure regulating chamber 5a and this pressure regulating chamber 5a′ becomes lower than the above-mentioned secondary pressure, the lower shaft 512 of the mobile main body 51 falls due to the impetus of the spring member for the diaphragm 55 and opens the through hole 232a, and it becomes possible again for the fuel F to flow into the pressure regulating chamber 5a through this pressure regulating chamber 5a′ and the pressure regulating chamber 5a. In this manner, the diaphragm 50 maintains the fuel F at a roughly fixed secondary pressure by ceaselessly moving up and down relative to the fluctuations of the pressure of the fuel F. At this time, since a flow path 50a that communicates with this pressure regulating chamber 5a′, which is formed on the lower side, and the pressure regulating chamber 5a, which is formed on the upper side, is formed on the inside of the diaphragm 50, it is possible to make the fuel F inside the container main body 2, into which it has flowed from the through hole 232a (lower side) flow to the valve 4 (upper side) after it is regulated to the secondary pressure.

In this manner, since a pressure regulating mechanism 5 that regulates to a secondary pressure lower than the primary pressure inside the container main body 2, and that causes [the fuel F] to flow out to the valve is provided, the fuel cartridge for a fuel cell 1 can supply fuel 1 at a fixed flow rate, without a pressure regulator being loaded on the device on which the fuel cell is loaded, so it is possible to prevent the fuel F from being supplied abruptly and the electrolytic membrane from being damaged, and it further possible to miniaturize the above-mentioned device by the amount of space on which a pressure regulator is loaded. In addition, the pressure regulating mechanism 5 is disposed on the inside of the connection part 22, so the open space inside the connection part 22 is reduced. Owing to this, it is possible to reduce the fuel that ends up remaining, albeit in minute quantities, inside the connection part 22, when the connection between the connection part 22 and the device is loosened, and the supply port 41a is closed.

As shown in FIG. 3, the piston 3 is composed of a main body member 31 that has one groove 310 that extends along the entire periphery on the outer peripheral surface in a roughly columnar state, and an O-ring 32 that fits in said groove 310 and is formed from a material with elasticity such as rubber, and the O-ring is disposed such that the outer periphery is in airtight contact with the inner surface of the inner container 23, and can move up and down through the inside of the inner container 23. The piston 3 functions as a moving bulkhead that partitions the space in contact with the upper surface into a space for housing fuel 11 and the space that is in contact with the lower surface into a space for pushing out 12, respectively, and when the fuel F of the upper surface is pressurized by the pressure of the compressed gas G that acts on the bottom surface, and the stem 42 is activated so it opens, it acts so as to push out the fuel F.

It is preferable that the piston 3 in the present invention is formed with polypropylene (PP) from the standpoint of fuel resistance, stability of dimensions and ease of molding, and it may also be formed of such resins as polyethylene (PE), polyoxymethyl (POM), polyethylene terephthalate (PET), polyethylene naphthalate (PEN), polybutylene terephthalate (PBT), polybutylene naphthalate (PBN) and polytetrafluoroethylene (PTFE).

In addition, by applying a covering layer formed with PTFE resin that does not elute in fuel F, diamond-like carbon (DLC) resin or polyparaxylylene resin, and in particular parylene N (a registered trademark of Nippon Paraylene KK; this indicates polyparaxylylene) to either the surface where the container main body 2 and the piston 3 slide in contact, that is, the outer top surface of the O-ring 32, or the inner wall surface of the inner container 23, it is composed such that the piston's resistance to movement is attenuated, and reliable and good action is ensured even if the pressure of the compressed gas G is low.

In addition, the inventive piston 3 may be formed with silicone rubber. In this case, it is possible to attenuate the piston's resistance to movement without applying the above-mentioned covering layer, so even if an elastic body 24 is not disposed below the piston 3, it is possible for the piston to return from the re-lowered state to a state where it tightly seals the space for housing the fuel 11 when the compressed gas G (described below) is sealed in.

In addition, from the standpoint of raising the ease of sliding, the above-mentioned covering layer is applied also to the outer upper surface of the connection seal member 45 that is fitted to the outer periphery of the upper end of the valve 4.

A description is next provided of the sealing of the compressed gas G in the space for pushing out 12 and the injection of the fuel F to the space for housing the fuel 11. The sealing of the compressed gas G shall be carried out before the injection of the fuel F to the space for housing the fuel 11.

First of all, the gas injection port of a fuel filling machine (not shown in the figure) is joined to the supply port 41a, the stem 42 is activated to open by a pushing in action, and the compressed gas G flows into the space for housing fuel 11 through the valve 4 and the flow path 50a. In response to this, the piston 3 falls, and as shown in FIG. 1, owing to the fact that the compressed gas G is further injected from a position where the flexible body 24 has its natural length, the piston 3 presses and deforms the flexible body 24, and moves further towards the bottom inner surface 21a of the notch 231. In a state where the piston 3 falls to the lowest point, the upper end part of the notch is upwards from the O-ring 32 of the piston 3, the compressed gas G is injected from the space for housing fuel 11 to the space for pushing out 12 through the notch 231. Then, when the inside of the space for pushing out 12 reaches the prescribed pressure, the injection of the compressed gas G is stopped.

Next, the stem 42 is activated to open again, and the compressed gas G inside the space for housing fuel 11 is discharged. In response to this the piston 3 rises due to the repulsive force of the elastic body 24, and as shown in FIG. 2 it returns to a state where the space for housing fuel 11 is tightly sealed. Then, owing to the further discharge of the compressed gas G, the piston 3 rises and moves to the upper end of the inner container 23 in a state where the pressure of the compressed gas G in the space for pushing out 12 acts on the lower surface, and the compressed gas G inside the space for housing fuel 11 is discharged, and owing to this the compressed gas G is sealed in the space for pushing out 12. At this time, there are no particular restrictions provided that the pressure of the compressed gas G is a pressure at which it is possible to discharge while pushing out all the fuel F that is filled in the space for housing fuel 11 as described below, by means of the piston 3.

After that, a fuel injection means is connected to the supply port 41a, and fuel F is injected to the space for housing fuel 11 through the valve 4 and the flow path 50a, and due to this the piston 3 is lowered and a prescribed amount of fuel F is housed in the space for storing fuel 11, and the fuel cartridge for a fuel cell 1 is composed. It is possible refill the fuel F inside it and reuse a fuel cartridge for a fuel cell 1 that is composed like this when the fuel F housed inside it decreases or runs out.

In the present mode of embodiment, the container main body 2 has a double structure, but the inventive pressurized container is not limited to this, and the design thereof can be modified as appropriate, and may be a single container structure with a structure wherein a liquefied gas such as LPG (liquefied petroleum gas) DME (dimethyl ether) and CFC (chlorofluorocarbon) or a compressed gas like carbon dioxide gas or nitrogen gas are housed as a spray agent along with the fuel F inside the container main body that is formed with a single container structure, and the fuel F is turned into a mist or foam and emitted by its own force to the outside the container main body, by the pressure of the above-mentioned liquefied gas or the above-mentioned compressed gas. In this case, the extrusion means P becomes the above-mentioned liquefied gas or the above-mentioned compressed gas.

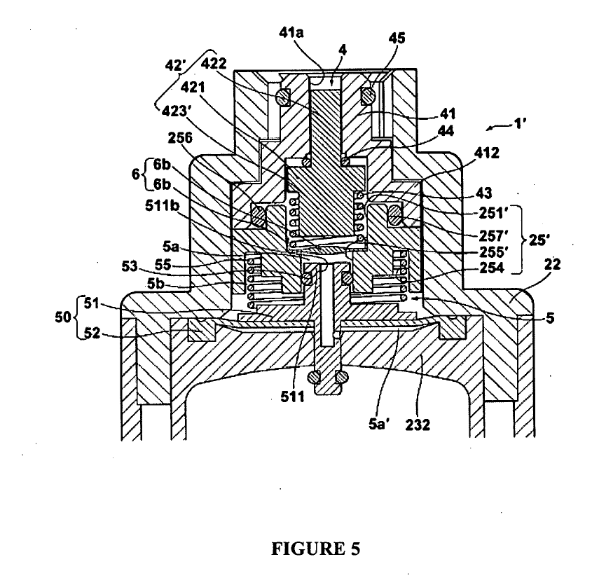

Next, a description is provided of another mode of embodiment of the fuel cartridge for a fuel cell 1′ for the present invention. FIG. 5 is an enlarged section of the connection part of the fuel cartridge for a fuel cell 1′ for the present mode of embodiment. For the sake of convenience, the side that connects to the fuel cell (upwards in FIG. 5) is the upper side. Those items in the fuel cartridge for a fuel cell 1′ for the present mode of embodiment that have a structure that is roughly the same as that of the fuel cartridge for a fuel cell 1 for the above-described mode of embodiment are indicated by the same number and letters of the key, and a detailed description thereof is omitted here, and a detailed description will be provided only for those items that have a different structure.

As shown in FIG. 5, the fuel cartridge for a fuel cell 1′ for the present mode of embodiment is equipped with a filter 6 between the upper end side of the pressure regulating mechanism 5 and the valve 4.

The valve 4 in the present mode of embodiment is roughly the same as that in the fuel cartridge for a fuel cell 1 in the above-described mode of embodiment, but the structure of the stem 42 differs somewhat. In the case of the stem 42′ in the present mode of embodiment, the diameter of the lower shaft part 423′ is formed larger than the diameter of the upper shaft part 422, and a spring member for a valve 43 is installed on the outer periphery of the lower shaft part 423′. Then, the lower shaft part 423′ on which the spring member for a valve 43 is installed is inserted in the through hole 251′ (described below) can move in an axial direction (the up and down direction).

The intermediate member 25′ that is fixed to the inside of the connection part 22 has a roughly columnar shape with a through hole 251′ in roughly the center, and an annular step part 257′ with which the lower end 412 of the housing main body 412 is in direct contact is formed on the outer peripheral rim of the upper surface, and is fixed to the inner surface of the housing main body 412 through an O-ring for an intermediate member 256 that is installed on said annular step part 257′. In addition, on roughly the center of the bottom surface of the through hole 251′ there is disposed filter 6, such that a shaft hole 255′ with a diameter that is smaller than that of the through hole 251′ through which the upper shaft 511 of the mobile main body 51 is inserted is formed by penetrating completely through downwards so that said shaft hole 255′ is blocked.

The filter 6 has a round plate shape that is equipped in roughly the center thereof with a filter elastic body 6a that blocks the shaft hole 255′, and is disposed on the inside of the through hole 251′ such that a cylindrical peripheral wall 6b is provided on the peripheral rim (outer periphery), and the outer peripheral surface of said peripheral wall 6b is in direct contact with the inner peripheral wall of the through hole 251′, and the bottom surface of the filter 6 is in direct contact with the bottom surface of the through hole 251′. Then, the lower end of the spring member for a valve 43 is in direct contact with the upper surface of the filter 6 such that it surrounds the filter flexible body 6a. The flow rate of the fuel F that is discharged from the discharge port 511b of the mobile main body 51 is further regulated and moreover the foreign matter therein is eliminated by this filter 6. Owing to this, the flow rate of the fuel F that is regulated to a fixed secondary pressure with the pressure regulating mechanism 5 is further regulated, and the foreign matter therein is eliminated, after which it is supplied to the valve 4, so it is possible to prevent foreign matter from being mixed into the valve 4 and the fuel cell, and it moreover becomes possible to carry out stable fuel supply. It is possible to use for the filter 6 in the present mode of embodiment the flow rate regulating filter disclosed in “Method for Manufacturing a Flow Rate Regulating Filter and a Flow Rate Regulating Filter” (Unexamined Japanese Patent Application Number 2005-353299) that was previously filed by the present application, and a detailed description thereof is omitted here.

In addition, on the lower surface of the intermediate member 25′ there is formed a second annular groove 254 wherein the upper part of the spring member for a diaphragm 55 is inserted to the outside from the through hole 251′ surrounding the shaft hole 255′. At this time, the through hole 251′ and the second annular groove 254 are formed coaxially, and are formed such that the bottom surface of the through hole 251′ and the upper surface of the second annular groove 254 are positioned in the same plane. Owing to this the spring member for the valve 43 and the spring member for the diaphragm 55 have different diameters, and are respectively disposed coaxially such that the lower end part of the spring member for a valve 43 and the upper end part of the spring member for a diaphragm 55 are positioned in the same plane. In the present mode of embodiment, a structure wherein the bottom surface of the through hole 251′ and the upper surface of the second annular groove 254 are positioned in the same plane has been used, but the present invention is not limited to this, and the structure may be one for example where the upper surface of the second annular groove 254 is positioned above the bottom surface of the through hole 251′. In this case, the spring member for the valve 43 and the spring member for the diaphragm 55 are disposed such that at least a part thereof overlaps in the expansion and contraction direction of said springs.

### LEGEND

1, 1′ . . . Fuel cartridge for a fuel cell
11 . . . Space for housing fuel
12 . . . Space for pushing out
2 . . . Container main body
21 . . . Outer container
21a . . . Bottom inner surface
22 . . . Connection part
23 . . . Inner container
232 . . . Partition wall
232a . . . Communication hole
24 . . . Elastic body
25, 25′ . . . Intermediate member
251, 251′ . . . Through hole
255, 255′ . . . Shaft hole
3 . . . Piston
4 . . . Valve
41 . . . Housing
41a . . . Supply port
42 . . . Stem
43 . . . Spring member for the valve
5 . . . Pressure regulating mechanism
5a . . . Pressure regulating chamber
5a′ . . . This pressure regulating chamber
5b . . . Air chamber
50 . . . Diaphragm
50a . . . Flow path
51 . . . Mobile main body
511 . . . Upper shaft (first shaft part)
511a . . . Upper annular groove part (first annular groove part)
511b . . . Discharge part
512 . . . Lower shaft (second shaft part)
512a . . . Lower annular groove part (second annular groove part)
512b . . . Inflow part
52 . . . Diaphragm main body
53 . . . Sliding bulkhead member
54 . . . Pressure regulating valve
55 . . . Spring member for a diaphragm
6 . . . Filter
F . . . Fuel
G . . . Compressed gas
P . . . Push out means

What is claimed is:

1. A fuel cartridge for a fuel cell, which is equipped with a container main body that is equipped with a connection part that connects to the fuel cell, and that houses inside it the fuel that is supplied to the above-mentioned fuel cell, and the push out means for pushing out said fuel, and a valve that is provided on the above-mentioned connection part, that has a supply port for supplying fuel to the above-mentioned fuel cell, and that opens the above-mentioned supply port in response to the operation of connecting the above-mentioned container main body to the above-mentioned fuel cell, wherein one end communicates with the above-mentioned connection part, and the other end communicates with the inside of the above-mentioned container main body, and there is provided a pressure regulating mechanism that causes the fuel housed in said interior to flow out to the above-mentioned valve by regulating to a secondary pressure lower than the primary pressure inside the above-mentioned container main body.

2. The fuel cartridge for a fuel cell described in claim 1, wherein the above-mentioned one end of the above-mentioned pressure regulating mechanism is equipped with a filter in the space between it and the above-mentioned valve.

3. The fuel cartridge for a fuel cell described in claim 1, being a fuel cartridge for a fuel cell whose above-mentioned container main body is equipped with a partition wall that has a communication hole in roughly the center between the above-mentioned connection part and the above-mentioned interior, and the above-mentioned connection part is equipped with a roughly columnar intermediate member whose outer circumferential surface is fixed to the inner surface of the above-mentioned connection part, and that has a shaft hole in roughly the center, between the above-mentioned valve and the above-mentioned pressure regulating mechanism, wherein the above-mentioned pressure regulating mechanism is equipped with a diaphragm that has a first shaft part that protrudes to the above-mentioned valve side and is inserted in the above-mentioned shaft hole, and a second shaft part that protrudes to the above-mentioned internal side and is inserted through the above-mentioned communication hole, and that displaces in response to the pressure fluctuations of the above-mentioned fuel, the above-mentioned first shaft part has a first annular groove part on the outer periphery of the tip, and on said groove part there is installed a sliding bulkhead member that slides through the inner surface of the above-mentioned shaft hole, and that partitions it into a pressure regulating chamber in communication with the above-mentioned valve that is formed on the above-mentioned valve side and an air chamber housing air that is formed on the above-mentioned partition wall side, a discharge port that is in communication with the above-mentioned pressure regulating chamber and that discharges the above-mentioned fuel is provided on the tip of the above-mentioned first shaft part, the above-mentioned second shaft part has a second annular groove part on the outer periphery of its tip, and on said groove part there is installed pressure regulating valve that opens and closes the above-mentioned communication hole in response to the movement of said second shaft part in an axial direction, an inflow port that communicates with the above-mentioned interior and through which the above-mentioned fuel flows when the above-mentioned pressure regulating valve is open is provided on the outer peripheral surface of the above-mentioned valve side from said pressure regulating valve of the above-mentioned second shaft part, and a flow path that reaches from the above-mentioned inflow port to the above-mentioned discharge port is formed on the inside of the above-mentioned diaphragm.

4. The fuel cartridge for a fuel cell described in claim 3, wherein the above-mentioned intermediate member is equipped on the above-mentioned valve side with a spring member used for a valve, one end of which is placed in direct contact with said valve, and the other end of which is in direct contact with the above-mentioned intermediate member, and that expands and contracts in response to the displacement of the above-mentioned valve, and is equipped on the above-mentioned diaphragm side with a with a spring member used for a diaphragm, one end of which is placed in direct contact with said diaphragm, and the other end of which is in direct contact with the above-mentioned intermediate member, and that expands and contracts in response to the displacement of the above-mentioned diaphragm, and the above-mentioned spring member for a valve and the above-mentioned spring member for a diaphragm have different diameters, and are disposed such that at least a part of each overlaps in the expansion and contraction direction of said spring coaxially.

5. The fuel cartridge for a fuel cell described in claim 4, wherein the above-mentioned spring member for a valve has a diameter that is smaller than that of the above-mentioned spring member for a diaphragm.

6. The fuel cartridge for a fuel cell described in claim 1, wherein the above-mentioned push out means is the compressed gas or liquefied gas housed inside the above-mentioned container main body.

7. The fuel cartridge for a fuel cell described in claim 1, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

8. The fuel cartridge for a fuel cell described in claim 2, being a fuel cartridge for a fuel cell whose above-mentioned container main body is equipped with a partition wall that has a communication hole in roughly the center between the above-mentioned connection part and the above-mentioned interior, and the above-mentioned connection part is equipped with a roughly columnar intermediate member whose outer circumferential surface is fixed to the inner surface of the above-mentioned connection part, and that has a shaft hole in roughly the center, between the above-mentioned valve and the above-mentioned pressure regulating mechanism, wherein the above-mentioned pressure regulating mechanism is equipped with a diaphragm that has a first shaft part that protrudes to the above-mentioned valve side and is inserted in the above-mentioned shaft hole, and a second shaft part that protrudes to the above-mentioned internal side and is inserted through the above-mentioned communication hole, and that displaces in response to the pressure fluctuations of the above-mentioned fuel, the above-mentioned first shaft part has a first annular groove part on the outer periphery of the tip, and on said groove part there is installed a sliding bulkhead member that slides through the inner surface of the above-mentioned shaft hole, and that partitions it into a pressure regulating chamber in communication with the above-mentioned valve that is formed on the above-mentioned valve side and an air chamber housing air that is formed on the above-mentioned partition wall side, a discharge port that is in communication with the above-mentioned pressure regulating chamber and that discharges the above-mentioned fuel is provided on the tip of the above-mentioned first shaft part, the above-mentioned second shaft part has a second annular groove part on the outer periphery of its tip, and on said groove part there is installed pressure regulating valve that opens and closes the above-mentioned communication hole in response to the movement of said second shaft part in an axial direction, an inflow port that communicates with the above-mentioned interior and through which the above-mentioned fuel flows when the above-mentioned pressure regulating valve is open is provided on the outer peripheral surface of the above-mentioned valve side from said pressure regulating valve of the above-mentioned second shaft part, and a flow path that reaches from the above-mentioned inflow port to the above-mentioned discharge port is formed on the inside of the above-mentioned diaphragm.

9. The fuel cartridge for a fuel cell described in claim 8, wherein the above-mentioned intermediate member is equipped on the above-mentioned valve side with a spring member used for a valve, one end of which is placed in direct contact with said valve, and the other end of which is in direct contact with the above-mentioned intermediate member, and that expands and contracts in response to the displacement of the above-mentioned valve, and is equipped on the above-mentioned diaphragm side with a with a spring member used for a diaphragm, one end of which is placed in direct contact with said diaphragm, and the other end of which is in direct contact with the above-mentioned intermediate member, and that expands and contracts in response to the displacement of the above-mentioned diaphragm, and the above-mentioned spring member for a valve and the above-mentioned spring member for a diaphragm have different diameters, and are disposed such that at least a part of each overlaps in the expansion and contraction direction of said spring coaxially.

10. The fuel cartridge for a fuel cell described in claim 9, wherein the above-mentioned spring member for a valve has a diameter that is smaller than that of the above-mentioned spring member for a diaphragm.

11. The fuel cartridge for a fuel cell described in claim 2, wherein the above-above-mentioned push out means is the compressed gas or liquefied gas housed inside the above-mentioned container main body.

12. The fuel cartridge for a fuel cell described in claim 2, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

13. The fuel cartridge for a fuel cell described in claim 3, wherein the above-mentioned push out means is the compressed gas or liquefied gas housed inside the above-mentioned container main body.

14. The fuel cartridge for a fuel cell described in claim 3, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

15. The fuel cartridge for a fuel cell described in claim 4, wherein the above-mentioned push out means is the compressed gas or liquefied gas housed inside the above-mentioned container main body.

16. The fuel cartridge for a fuel cell described in claim 4, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

17. The fuel cartridge for a fuel cell described in claim 5, wherein the above-mentioned push out means is the compressed gas or liquefied gas housed inside the above-mentioned container main body.

18. The fuel cartridge for a fuel cell described in claim 5, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

19. The fuel cartridge for a fuel cell described in claim 8, wherein the above-mentioned push out means is the compressed gas or liquefied gas housed inside the above-mentioned container main body.

20. The fuel cartridge for a fuel cell described in claim 8, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

21. The fuel cartridge for a fuel cell described in claim 9, wherein the above-mentioned push out means is the compressed gas or liquefied gas housed inside the above-mentioned container main body.

22. The fuel cartridge for a fuel cell described in claim 9, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.

23. The fuel cartridge for a fuel cell described in claim 10, wherein the above-mentioned push out means is the compressed gas or liquefied gas housed inside the above-mentioned container main body.

24. The fuel cartridge for a fuel cell described in claim 10, wherein the above-mentioned container main body communicates with the above-mentioned pressure regulating mechanism, and is a double container composed of a cylindrical inner container equipped with piston that comprises the above-mentioned push out means on its interior, and an outer container that forms a space for pushing out that seals the compressed gas or liquefied gas on the outside of said inner container.
